(19) United States
(12) Patent Application Publication
(10) Pub. No.: US 2024/0014622 A1
(43) Pub. Date: Jan. 11, 2024

(54) LASER DEVICE AND PROCESSING DEVICE

(71) Applicant: FURUKAWA ELECTRIC CO., LTD., Tokyo (JP)

(72) Inventors: Shigehiro TAKASAKA, Tokyo (JP); Yoshihiro EMORI, Tokyo (JP); Shinichi ARAI, Tokyo (JP); Ryuichi SUGIZAKI, Tokyo (JP)

(73) Assignee: FURUKAWA ELECTRIC CO., LTD., Tokyo (JP)

(21) Appl. No.: 18/472,597

(22) Filed: Sep. 22, 2023

Related U.S. Application Data
(63) Continuation of application No. PCT/JP2022/013016, filed on Mar. 22, 2022.

(30) Foreign Application Priority Data
Mar. 24, 2021 (JP) 2021-050843

(51) Int. Cl. H01S 3/067; H01S 3/094

(52) U.S. Cl. CPC H01S 3/06737; H01S 3/094003

(57) ABSTRACT

A laser device includes: a seed light source configured to output a laser light having a single mode; a multicore fiber including at least one core group having at least one core, each of the core in the core group being optically coupled to neighboring cores; and an optical coupler configured to input the laser light to the core group, wherein in the multicore fiber, the laser light propagates through the core group in a super mode representing propagation mode of the core group.

This application is a continuation of International Application No. PCT/JP2022/013016, filed on Mar. 22, 2022 which claims the benefit of priority of the prior Japanese Patent Application No. 2021-050843, filed on Mar. 24, 2021, the entire contents of which are incorporated herein by reference.

### BACKGROUND

The present disclosure relates to a laser device and a processing device.

In a single-mode fiber laser, since the cross-sectional area of the core is relatively smaller, the intensity and the density of the light in the core is high. For that reason, the nonlinear optical phenomena, such as the stimulated Raman scattering (SRS), occurring in an optical fiber become a barrier to achieving a high level of power; and the known output power is, for example, lower than 10 kW (refer to Kensuke Shima, Shinya Ikoma, Keisuke Uchiyama, Yuya Takubo, Masahiro Kashiwagi, and Daiichiro Tanaka “5-kW single stage all-fiber Yb-doped single-mode fiber laser for materials processing”, Proc. SPIE 10512, Fiber Lasers XV: Technique and Systems, 105120C (26 Feb. 2018) and Yuya Takubo, Shinya Ikoma, Keisuke Uchiyama, Masahiro Kashiwagi, Kensuke Shima “5 kW single-mode fiber laser” (in Japanese), Fujikura Technical Journal No. 131, July 2018).

In U.S. patent Ser. No. 09/559,483, a technique is disclosed for holding down the impact of the nonlinear optical phenomena using a multi-core fiber.

### SUMMARY

In the technique disclosed in U.S. patent Ser. No. 09/559,483, the phase of the light amplified in each core is detected; and, using a phase plate meant for input-light phase control, feedback control is performed with respect to the phase of the light that is input to each core, so that the same phase is achieved for the light in all cores. Because of that, the configuration is complex. Moreover, in the technique disclosed in U.S. patent Ser. No. 09/559,483, it is necessary to use a device for detecting the phase of the amplified high-power light. However, when the high-power light is input to that device, heat gets produced due to the light loss occurring in the device. Particularly in the case of a high-power light, even if the light loss is relatively smaller, there is a relatively greater amount of heat generation. Hence, heat treatment becomes an issue, and the technique disclosed in U.S. patent Ser. No. 09/559,483 sometimes becomes difficult to implement.

There is a need for a laser device that has a simple configuration and that is suitable to achieve a high level of power.

According to one aspect of the present disclosure, there is provided a laser device including: a seed light source configured to output a laser light having a single mode; a multicore fiber including at least one core group having at least one core, each of the core in the core group being optically coupled to neighboring cores; and an optical coupler configured to input the laser light to the core group, wherein in the multicore fiber, the laser light propagates through the core group in a super mode representing propagation mode of the core group.

### BRIEF DESCRIPTION OF THE DRAWINGS

FIG. 1 is a schematic configuration diagram of a laser device according to a first embodiment;

FIGS. 2A to 2D are schematic diagrams for explaining a super mode;

FIG. 3 is a schematic configuration diagram of a laser device according to a second embodiment;

FIG. 4 is a schematic configuration diagram of a laser device according to a third embodiment;

FIG. 5 is a schematic diagram for explaining the power distribution of the laser light that is output from the laser device according to the third embodiment;

FIG. 6 is a schematic diagram for explaining the power distribution of the laser light that is output from a laser device according to a second modification example of the third embodiment;

FIG. 7 is a schematic configuration diagram of a processing device according to a fourth embodiment;

FIG. 8 is a schematic configuration diagram of a processing device according to a fifth embodiment;

FIG. 9 is a schematic configuration diagram of a laser device according to a sixth embodiment;

FIG. 10 is a schematic diagram for explaining an exemplary configuration of an optical coupler; and

FIG. 11 is a schematic configuration diagram of a laser device according to a reference embodiment.

### DETAILED DESCRIPTION

Exemplary embodiments of the present disclosure are described below with reference to the accompanying drawings. However, the present disclosure is not limited by the embodiments described below. In the drawings, identical or corresponding constituent elements are referred to by the same reference numerals, and the same explanation is not repeated. Meanwhile, the drawings are schematic in nature, and it needs to be noted that the relationship among the dimensions of the constituent elements or the proportion of the constituent elements may be different than the actual situation. Among the drawings too, sometimes the relationship among the dimensions and the proportion may be different. Regarding the terms that are not specifically defined in the present written description, it is assumed that the definitions and the measurement methods given in ITU-T G.650.1 and ITU-T G.650.2 are followed (ITU-T stands for International Telecommunication Union Telecommunication Standardization Sector).

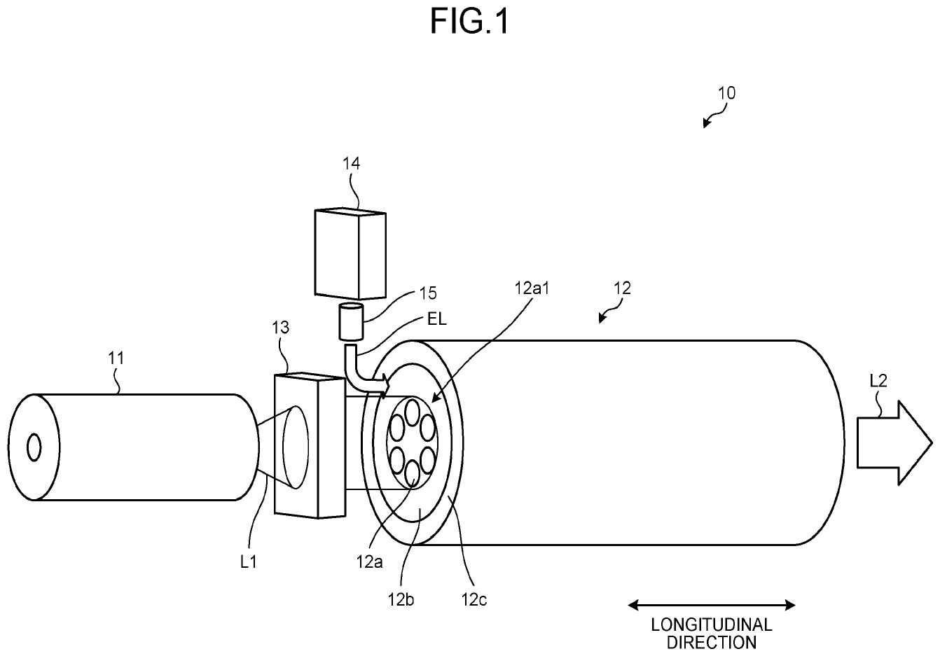

FIG. 1 is a schematic configuration diagram of a laser device according to a first embodiment. A laser device 10 includes a seed light source 11, a multicore gain fiber 12, an optical coupler 13, a pumping light source 14, and a pumping light coupler 15.

Given below is the explanation of a configuration of the laser device 10. The seed light source 11 is configured to output a laser light L1 of the single mode (LP01 mode) type. For example, the seed light source 11 is an ytterbium doped fiber amplifier (YDFA) in which a single-mode optical fiber is used. In that case, the wavelength of the laser light L1 is included in the wavelength band of 1100 nm, and is equal to 1070 nm, for example.

The multicore gain fiber 12 includes: one core group 12a1 having six cores 12a; an inner cladding 12b that surrounds the outer periphery of the cores 12a; and an outer cladding 12c that surrounds the outer periphery of the inner cladding 12b. Thus, the multicore gain fiber 12 is a six-core-type multicore fiber as well as a double-cladding-type gain fiber.

The cores 12a are arranged in a circular pattern along the cross-sectional surface orthogonal to the longitudinal direction. The cores 12a are doped with, for example, germanium (Ge) or aluminum (Al) as a refractive-index adjustment dopant meant for increasing the refractive index. Moreover, the cores 12a are doped with ytterbium (Yb) that is a rare earth element representing an optical amplification medium.

In the core group 12a1, each of the six cores 12a is optically coupled to its neighboring cores 12a. The cores that are optically coupled to each other are also called binding cores. When two cores 12a are optically coupled to each other, the optical coupling may be defined as the magnitude of the inter-core crosstalk value. For example, from one end of the multicore gain fiber 12, when the main light is input to a particular core 12a and when a test light having the same power and the same wavelength as the main light is input to another core 12a, some part of the test light that is input to the other core 12a gets coupled to the concerned particular core 12a, and is output along with the main light from that particular core 12a. In that case, the ratio of the power of the test light with respect to the power of the main light as output from the particular core 12a is defined as the crosstalk (XT) value at the wavelength of the main light and the test light. Herein, the XT value is devoid of the loss such as the absorption of the main light or the test light in the core 12a, and is devoid of the impact of the gain.

When two cores 12a are optically coupled, it implies that the XT value is greater than −30 dB. If the XT value is greater than −20 dB, then the optical coupling is stronger; and, if the XT value is greater than −10 dB, then the optical coupling is even stronger. The XT value has the maximum value of 0 dB. There are times when the XT value is desirably as large as possible. However, it is desirable that the XT value is designed to be equal to the intended value according to the required characteristics. Meanwhile, the XT value may be adjusted by varying the core diameter and the refractive index of each core 12a, by varying the refractive index profile of each core 12a, by varying the distance between the neighboring cores 12a, or by varying the relative refractive index difference of the cores 12a with respect to the inner cladding 12b.

The inner cladding 12b has a lower refractive index than the maximum refractive index of the cores 12a. The refractive index profile of each core 12a is, for example, of the step-index type. However, there is no particular restriction regarding that.

When each core 12a has the refractive index profile of the step-index type, the core diameter and the refractive index of each core 12a and a relative refractive index difference A of that core with respect to the inner cladding 12b are set in such a way that the light having the wavelength of the laser light L1 propagates through the core 12a in the single mode (LP01 mode). Even when the refractive index profile of each core 12a is not of the step-index type, the core diameter and the refractive index of the core 12a may be appropriately set to ensure that the light having the wavelength of the laser light L1 propagates through the core 12a in the single mode (LP01 mode).

It is desirable that the core diameter of each core 12a is, for example, equal to or greater than 9 μm and equal to or smaller than 25 μm.

Herein, greater the core diameter, the lesser is the impact of the stimulated Raman scattering, and the greater may be the allowable light output. However, if the core diameter is too large, then the bending loss of the multicore gain fiber 12 increases and the allowable bending radius of the fiber also increases, thereby possibly causing restrictions on the handling. For example, if the core diameter is greater than 25 μm, then the allowable bending radius exceeds 80 mm. On the other hand, if the core diameter is smaller than 9 μm, then the bending loss is small thereby enabling achieving reduction in the allowable bending radius of the fiber to a few millimeters. As a result, the handling becomes easier. However, when a high-power light is propagated, it results in the occurrence of stimulated Raman scattering, and the monochromaticity of the output laser light (in FIG. 1, a laser light L2) sometimes undergoes a significant decline.

Meanwhile, although it is desirable that all cores 12a have the same core diameter and the same refractive index, it is not always a necessary condition.

The outer cladding 12c has a lower refractive index than the refractive index of the inner cladding 12b, and is made of resin, for example.

The optical coupler 13 receives the laser light L1 that is output by the seed light source 11, and inputs the laser light L1 to the core group 12a1. Regarding the configuration of the optical coupler 13, the detailed explanation is given later.

The pumping light source 14 is, for example, a multimode semiconductor laser that outputs a multimode pumping light EL. The wavelength of the pumping light EL is sufficient to cause light excitation of the optical amplification medium included in the cores 12a. When ytterbium is used as the optical amplification medium, the wavelength of the pumping light EL is, for example, 915 nm, 940 nm, or 976 nm.

The pumping light coupler 15 causes coupling of the pumping light EL, which is output from the pumping light source 14, to the inner cladding 12b of the multicore gain fiber 12. As far as the pumping light coupler 15 is concerned, an optical coupler having a known configuration may be used, such as a side-coupling-type coupler may be used in which an optical fiber for propagating the pumping light EL is placed along the lateral face of the inner cladding 12b and which causes coupling of the pumping light EL to the inner cladding 12b, or an end-coupling-type coupler may be used that inputs the pumping light EL from the end face of the inner cladding 12b. Alternatively, the pumping light coupler 15 may be an optical coupler having a spatial optical system used therein.

Given below is the explanation of the operations performed in the laser device 10. When the pumping light coupler 15 inputs the pumping light EL, which is output from the pumping light source 14, to the inner cladding 12b of the multicore gain fiber 12, the pumping light EL propagates through the inner cladding 12b and causes light excitation of the optical amplification medium included in each core 12a. As a result, each core 12a becomes able to amplify the laser light L1 input thereto. In this way, the multicore gain fiber 12 is configured to enable implementation of the cladding pumping method.

In the state in which each core 12a is able to amplify the laser light L1, the optical coupler 13 inputs the laser light L1 to the core group 12a1. Because of the optical coupler 13, the laser light L1 gets to have a greater beam diameter than the outer rim of the ring-like core group 12a1, and reaches the end face of the core group 12a1. Alternatively, because of the optical coupler 13, the laser light L1 gets divided into six beams, each of which reaches the end face of one core 12a. Then, the components of the laser light L1 are input to each core 12a. At that time, the components of the laser light L1 that are input to each core 12a have the substantially same phase and the substantially same power.

Upon being input to each core 12a, the laser light L1 propagates through the core group 12a1 of the multicore gain fiber 12 in a super mode. Herein, the super mode implies the propagation mode of the core group 12a1.

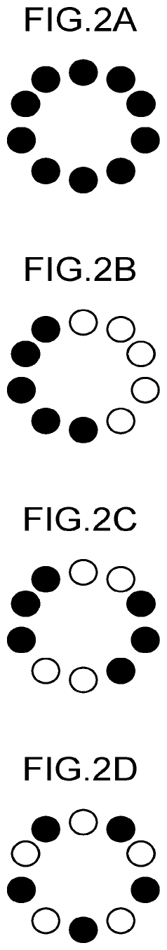

FIGS. 2A to 2D are schematic diagrams for explaining the super mode. With reference to FIGS. 2A to 2D, the explanation is given about a multicore fiber in which 10 cores (illustrated as circles) constitute the core group and are arranged in a circular pattern along the cross-sectional surface orthogonal to the longitudinal direction. The super mode represents the propagation mode implemented when the cores constituting the core group are binding cores; and has such a core distribution profile of the optical power and the optical phase that the relative power and the relative phase of the light propagating through each core is retained. In the core group, the light propagates with the field distributed across all cores. The profile of the super mode is set according to the symmetry of the arrangement of the cores.

FIG. 2A is a diagram illustrating a propagation mode in which all cores have the same phase of the light along a face orthogonal to the longitudinal direction of the multicore fiber, such as along the output end face. Such a propagation mode is called the fundamental mode. Meanwhile, the fundamental mode is not limited to have the arrangement of the cores as illustrated in FIG. 2A. That is, any propagation mode in which all cores have the same phase of the light along a face orthogonal to the longitudinal direction of the multicore fiber, such as along the output end face, is called a fundamental mode or a pseudo single mode. Meanwhile, in the ring-like arrangement illustrated in FIG. 2A, the power of the output light is substantially identical in all cores.

FIG. 2B is a diagram illustrating a propagation mode in which, along a face orthogonal to the longitudinal direction of the multicore fiber, such as along the output end face, a set of five neighboring cores have the same phase and the other set of five neighboring cores have the phase shifted by π. FIG. 2C is a diagram illustrating a propagation mode in which sets of three neighboring cores have the same phase and pairs of two cores neighboring to the three-core sets have the phase shifted by 7c. FIG. 2D is a diagram illustrating a propagation mode in which each pair of neighboring cores have the phase shifted by 7c. In FIGS. 2B, 2C, and 2D, the cores illustrated as filled circles have the same phase, and the cores illustrated as white circles have the phase shifted by 7c with respect to the cores illustrated as filled circles. With respect to the fundamental mode, those three propagation modes are called high-order modes.

As explained above, the components of the laser light L1, which is input to each core 12a, have the substantially same phase and the substantially same power. Hence, the laser light L1 causes selective excitation of the fundamental mode of the super mode, and propagates through the core group 12a1 in the fundamental mode. At that time, the intensity and the density of the laser light L1 becomes lower as compared to the case of propagating through one core 12a. Moreover, since each core 12a is in the state of being able to amplify the laser light L1, the laser L1 propagates through the core group 12a1 while getting amplified, and is output as the laser light L2 in the amplified form from the multicore gain fiber 12. The near-field image of the beam of the laser light L2 is circular in shape in an identical manner to the arrangement of the cores 12a in the core group 12a1. Moreover, the far-field pattern of the beam of the laser light L2 has an identical shape to the shape of the output from an individual single-mode core.

In the laser device 10 configured in the manner explained above, the laser light L1 propagates through the multicore gain fiber 12 in the fundamental mode of the super mode, gets amplified, and is output as the laser light L2. Thus, the laser light L1 may be amplified while keeping its intensity and its density to a relatively low level. As a result, the impact of the nonlinear optical phenomena may be held down, thereby making the condition suitable to achieve a high level of power. Moreover, since the laser light L1 is amplified by six cores 12a, it becomes possible to obtain the laser light L2 having a high level of power equal to or close to six times the power achieved when the laser light L1 is amplified by one core 12a.

Furthermore, in the laser device 10, there occurs inter-core optical coupling attributed to the binding cores. Hence, accompanying the changes in the shape of the multicore gain fiber 12 due to bending, twisting, or extension; even if the optical path lengths of the cores 12a become mutually different in the multicore gain fiber 12, the propagation in the fundamental mode is maintained regardless of such differences. Thus, the phase of the laser light L1, which is input to each core 12a, need not be physically controlled to ensure that the phase of the output laser light L2 is in accordance with the phase setting. That makes it possible to keep the configuration simple.

Moreover, in the laser device 10, the laser light L1 propagates through the core group 12a1 in the fundamental mode of the super mode. Accordingly, the components of the laser light L2 output from each core 12a have an identical phase and are stable in terms of time. That leads to a high level of temporal stability in the power and the beam shape of the laser light L2. On the other hand, for example, in the high-order modes as illustrated in FIGS. 2B to 2D, the phase relationship sometimes changes in terms of time and sometimes changes also due to the temperature variation and the vibration of the multicore gain fiber 12. Hence, there is a risk that the power and the beam shape of the output laser light is more unstable than in the fundamental mode.

Thus, in the core group 12a, when a high-order mode of the super mode gets excited, it is desirable to pay attention to satisfying the required level of stability. Moreover, for example, when the laser light L2 includes the components of the fundamental mode and the components of a high-order mode, the ratio of the power of the components of the high-order mode with respect to the power of the components of the fundamental mode (i.e., the extinction ratio) is desirably equal to or smaller than −10 dB and is more desirably equal to or smaller than −20 dB. In order to achieve such an extinction ratio, the phase difference in the components of the laser light L1, which is input to each core 12a, is desirably equal to or smaller than π/2, is more desirably equal to or smaller than π/4, and is still more desirably equal to or smaller than π/10. Moreover, the power difference in the components of the laser light L1 that is input to each core 12a is desirably within ±20%, is more desirably within ±10%, and is still more desirably within ±5%. At that time, when the laser light L2 is concentrated or collimated on the processing target using a field lens, the fluctuation in the processing position becomes equal to or smaller than 10% of the spot diameter, and the fluctuation in the optical power at the processing position becomes equal to or smaller than 10%.

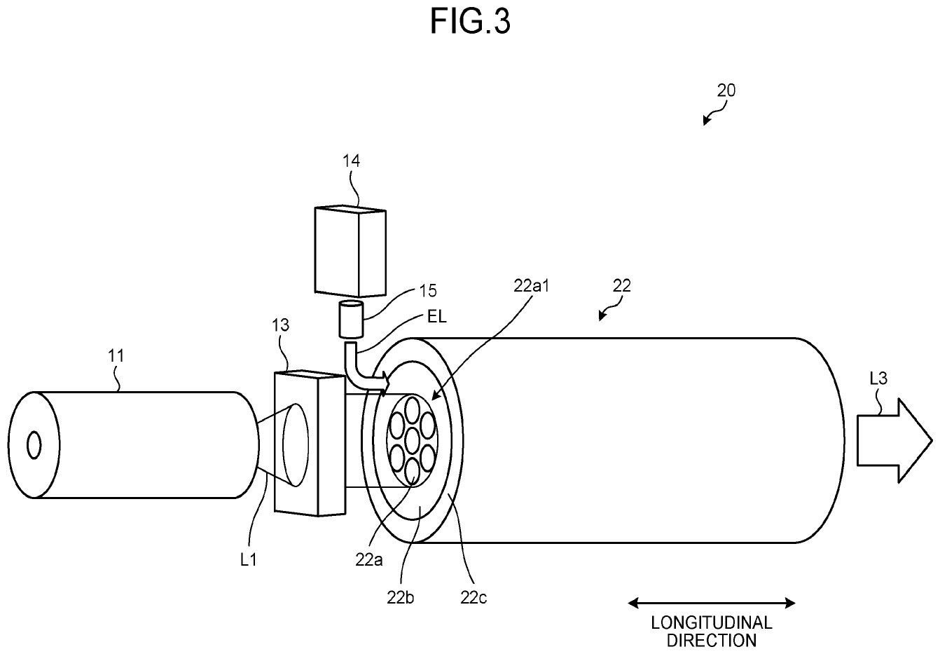

FIG. 3 is a schematic configuration diagram of a laser device according to a second embodiment. A laser device 20 is configured by substituting a multicore gain fiber 22 for the multicore gain fiber 12 in the laser device 10 illustrated in FIG. 1 according to the first embodiment. Regarding the constituent elements also included in the laser device 10, the explanation is not given again.

The multicore gain fiber 22 includes: one core group 22a1 having seven cores 22a; an inner cladding 22b that surrounds the outer periphery of the cores 22a; and an outer cladding 22c that surrounds the outer periphery of the inner cladding 22b. Thus, the multicore gain fiber 22 is a seven-core-type multicore fiber as well as a double-cladding-type gain fiber. The inner cladding 22b and the outer cladding 22c included in the multicore gain fiber 22 are same as the inner cladding 12b and the outer cladding 12c included in the multicore gain fiber 12. Hence, their explanation is not given again.

The cores 22a are arranged in the hexagonal close-packed state along the cross-sectional surface orthogonal to the longitudinal direction. Thus, it may also be said that the cores 22a are arranged in a triangular lattice. The cores 22a are doped with, for example, germanium (Ge) or aluminum (Al) as a refractive-index adjustment dopant meant for increasing the refractive index. Moreover, the cores 22a are doped with ytterbium (Yb) that is a rare earth element representing an optical amplification medium.

In the core group 22a1, each of the seven cores 22a is optically coupled to its neighboring cores 22a. Thus, from among the seven cores 22a, the core 22a positioned in the center is optically connected to each of the six cores 22a surrounding it.

The refractive index profile of each core 22a is, for example, of the step-index type. However, there is no particular restriction regarding that. Moreover, the core diameter and the refractive index of each core 22a and the relative refractive index difference of each core 22a with respect to the inner cladding 22b is set in such a way that the light having the wavelength of the laser light L1 propagates through each core 22a in the single mode. It is desirable that the core diameter of each core 22a is, for example, equal to or greater than 9 μm and equal to or smaller than 25 μm. Meanwhile, although it is desirable that all cores 22a have the same core diameter and the same refractive index, it is not always a necessary condition.

The operations performed in the laser device 20 are substantially same as the operations performed in the laser device 10. As far as the components of the laser light L1 input to each core 22a are concerned, the phase is substantially same. However, regarding the power, due to the fact that the power distribution of the laser light L1 has a gaussian shape, the components input to the core 22a positioned in the center have an increased power, while the components input to the six surrounding cores 22a have the substantially same power.

Upon being input to each core 22a, the laser light L1 propagates through the core group 22a1 of the multicore gain fiber 22 in the super mode. In this case, the super mode represents the fundamental mode (the pseudo single mode) equivalent to the LP01 mode.

In the multicore gain fiber 22, the laser light L1 propagates through the core group 22a1 while getting amplified, and is output as a laser light L3 in the amplified form from the multicore gain fiber 22. The power distribution of the laser light L3 reflects the arrangement of the cores 22a in the core group 22a1, and has a gaussian shape or a shape close to a gaussian shape.

In the laser device 20 configured in the manner explained above, in an identical manner to the laser device the nonlinear optical phenomena may be held down, thereby making the condition suitable to achieve a high level of power. Moreover, it becomes possible to obtain the laser light L3 having a high level of power equal to or close to seven times the power achieved when the laser light L1 is amplified by one core 22a.

Furthermore, in the laser device 20, in an identical manner to the laser device 10, the phase of the laser light L1, which is input to each core 22a, need not be physically controlled to ensure that the phase of the output laser light L3 is in accordance with the phase setting. That makes it possible to keep the configuration simple.

Furthermore, in the laser device 20, in an identical manner to the laser device 10, the power of the laser light L3 has a high level of temporal stability. Meanwhile, when the components of the fundamental mode and the components of a high-order mode are included in the laser light L3, the extinction ratio is desirably equal to or smaller than −10 dB and is more desirably equal to or smaller than −20 dB from the perspective of stability.

As a modification example of the multicore gain fiber 22, the number of cores 22a that are arranged in a triangular lattice or in the hexagonal close-packed state may be equal to three or may be equal to or greater than 19.

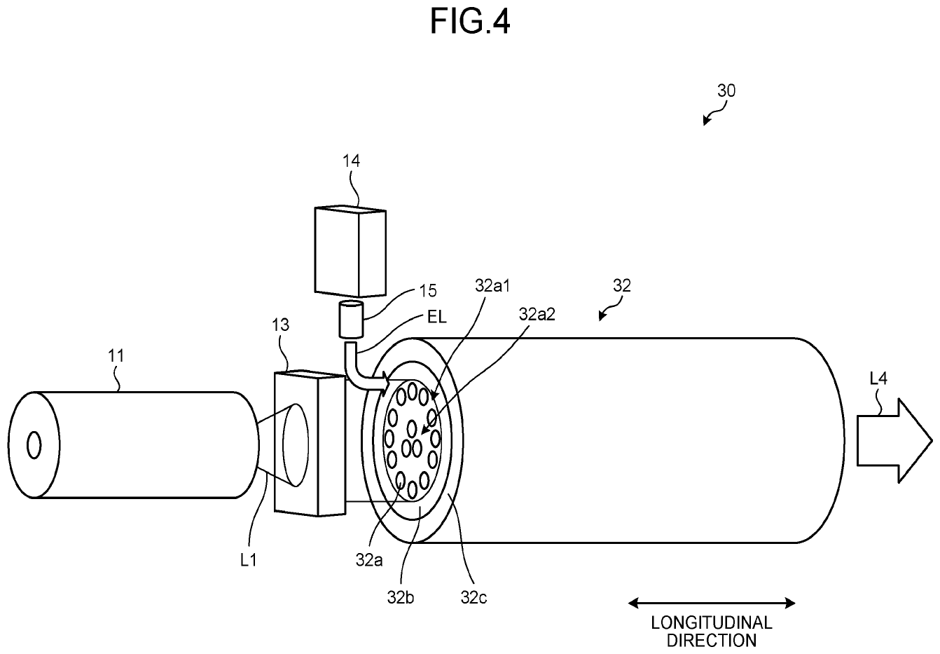

FIG. 4 is a schematic configuration diagram of a laser device according to a third embodiment. A laser device 30 is configured by substituting a multicore gain fiber 32 for the multicore gain fiber 12 in the laser device 10 illustrated in FIG. 1 according to the first embodiment. Regarding the constituent elements also included in the laser device 10, the explanation is not given again.

The multicore gain fiber 32 includes: a core group 32a1 having 12 cores 32a; a core group 32a2 having three cores 32a; an inner cladding 32b that surrounds the outer periphery of the cores 32a; and an outer cladding 32c that surrounds the outer periphery of the inner cladding 32b. Thus, the multicore gain fiber 32 is a 15-core-type multicore fiber as well as a double-cladding-type gain fiber. The inner cladding 32b and the outer cladding 32c included in the multicore gain fiber 32 are same as the inner cladding 12b and the outer cladding 12c included in the multicore gain fiber 12. Hence, their explanation is not given again.

The cores 32a included in the core group 32a1 are arranged in a circular pattern along the cross-sectional surface orthogonal to the longitudinal direction. The cores 32a included in the core group 32a2 are arranged in a triangular lattice along the cross-sectional surface orthogonal to the longitudinal direction. In this way, the cores 32a included in the core group 32a1, which is one of a plurality of core groups, are arranged in a ring-like manner around the other core group 32a2. That is, a two-tiered structure is formed with the core groups 32a1 and 32a2. The cores 32a are doped with, for example, germanium (Ge) or aluminum (Al) as a refractive-index adjustment dopant meant for increasing the refractive index. Moreover, the cores 32a are doped with ytterbium (Yb) that is a rare earth element representing an optical amplification medium.

In the core group 32a1, each of the 12 cores 32a is optically coupled to its neighboring cores 32a. In the core group 32a2 too, each of the three cores 32a is optically coupled to its neighboring cores 32a. However, the cores 32a included in different core groups, such as the core groups 32a1 and 32a2, are not optically coupled to each other. That is, the cores 32a included in the core group 32a1 are not optically coupled to the cores 32a included in the core group 32a2. Meanwhile, the XT value is equal to or smaller than −30 dB.

The refractive index profile of each core 32a is, for example, of the step-index type. However, there is no particular restriction regarding that. Moreover, the core diameter and the refractive index of each core 32a and the relative refractive index difference of each core 32a with respect to the inner cladding 32b is set in such a way that the light having the wavelength of the laser light L1 propagates through each core 32a in the single mode. It is desirable that the core diameter of each core 32a is, for example, equal to or greater than 9 μm and equal to or smaller than 25 μm. Meanwhile, although it is desirable that all cores 32a have the same core diameter and the same refractive index, it is not always a necessary condition.

The operations performed in the laser device 30 are substantially same as the operations performed in the laser device 10. However, the laser light L1 input to each core 32a propagates through the core groups 32a1 and 32a2 of the multicore gain fiber 32 in mutually different and independent super modes. That is, in the core group 32a1, the laser light L1 propagates in a circular super mode; and, in the core group 32a2, the laser light L1 propagates in the super mode equivalent to the LP01 mode.

In the multicore gain fiber 32, the laser light L1 propagates through the core groups 32a1 and 32a2 while getting amplified, and is output as a laser light L4 in the amplified form from the multicore gain fiber 32.

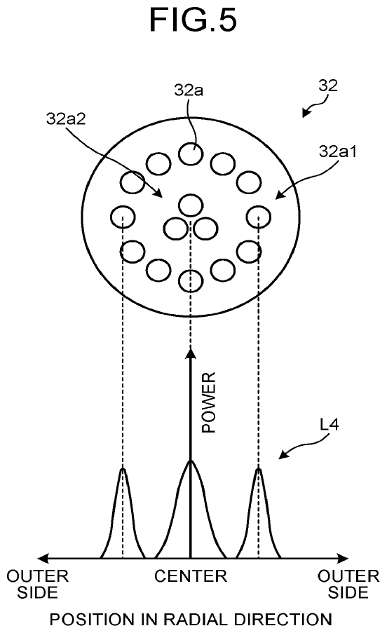

FIG. 5 is a schematic diagram for explaining the power distribution of the laser light L4 that is output from the laser device 30. In FIG. 5, the power of the laser light L4 is illustrated with respect to the cross-sectional surface perpendicular to the longitudinal direction of the multicore gain fiber 32 and with respect to positions in a radial direction in that cross-sectional surface. As illustrated in FIG. 5, from the core group 32a1, the laser light L4 is output in a circular beam shape; and, from the core group 32a2, the laser light L4 is output with a power distribution having a gaussian shape or a shape close to a gaussian shape.

In the laser device 30 configured in the manner explained above, in an identical manner to the laser device 10, the nonlinear optical phenomena may be held down, thereby making the condition suitable to achieve a high level of power. Moreover, it becomes possible to obtain the laser light L4 having a high level of power equal to or close to 15 times the power achieved when the laser light L1 is amplified by one core 32a.

Moreover, in the laser device 30, in an identical manner to the laser device 10, the phase of the laser light L1, which is input to each core 32a, need not be physically controlled to ensure that the phase of the output laser light L4 is in accordance with the phase setting. That makes it possible to keep the configuration simple.

Furthermore, in the laser device 30, in an identical manner to the laser device 10, the power of the laser light L4 has a high level of temporal stability. Meanwhile, when the components of the fundamental mode and the components of a high-order mode are included in the laser light L4, the extinction ratio is desirably equal to or smaller than −10 dB and is more desirably equal to or smaller than −20 dB from the perspective of stability.

Moreover, in the laser device 30, the input laser light L1 propagates through as well as gets amplified in the core groups 32a1 and 32a2 of the multicore gain fiber 32 in mutually different and independent super modes, and then the laser light L4 is output. Thus, in the laser device 30, the power relationship of the components of the laser light L1, which is input to the core group 32a1 as well as the core group 32a2, may be varied, thereby enabling varying the beam shape and the power distribution of the output laser light L4.

As a method for varying the power relationship of the components of the laser light L1 that is input to each of the core groups 32a1 and 32a2, it is possible to implement various methods. For example, if the optical coupler 13 is a passive component, then the power of the components of the laser light L1, which is input to each of the core groups 32a1 and 32a2, may be designed to achieve a predetermined ratio. Alternatively, if the optical coupler 13 is a component that is capable of actively controlling the power ratio of the components of the laser light L1 which is input to each of the core groups 32a1 and 32a2, then that power ratio may be actively controlled so as to be able to actively vary the beam shape, the power distribution, and the effective beam diameter of the output laser light L4.

Meanwhile, as a first modification example of the third embodiment, the seed light source 11 may be replaced by a seed light source configured to be able to output, as the laser light L1, a laser light having two or more single modes; so as to make it possible to vary the power ratio of the components of the laser light L1 that is input to each of the core groups 32a1 and 32a2. In that case, the seed light source may be configured using two or more fiber lasers.

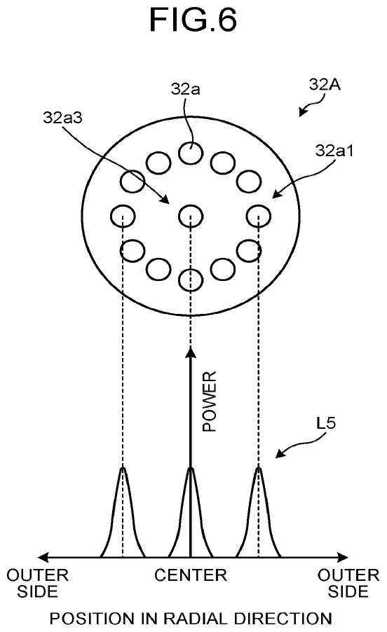

As a second modification example of the third embodiment, a multicore gain fiber 32A may be substituted for the multicore gain fiber 32. FIG. 6 is a schematic diagram for explaining the power distribution of the laser light that is output from a laser device according to the second modification example of the third embodiment. The multicore gain fiber 32A is configured by substituting a core group 32a3 for the core group 32a2 of the multicore gain fiber 32.

The core group 32a3 includes one core 32a. In this way, in the present written description, as long as a core group includes at least one core, it serves the purpose. Moreover, in an identical manner to the multicore gain fiber 32, the cores 32a included in different core groups, such as the core groups 32a1 and 32a3, are not optically coupled to each other. As illustrated in FIG. 6, assuming that a laser light L5 represents the laser light output from the multicore gain fiber 32A, the laser light L5 is output from the core group 32a1 in a circular beam shape and is output from the core group 32a3 with a power distribution having a gaussian shape or a shape close to a gaussian shape.

In the laser device according to the second modification example of the third embodiment, the relationship of the power of the components of the laser light L1, which is input to each of the core groups 32a1 and 32a3, may be varied, thereby enabling varying the beam shape, the power distribution, and the effective beam diameter of the output laser light L5.

As a method for varying the power relationship of the components of the laser light L1 that is input to each of the core groups 32a1 and 32a3, it is possible to implement various methods in an identical manner to the third embodiment. Moreover, in an identical manner to the first modification example of the third embodiment, using a seed light source configured to be able to output, as the laser light L1, a laser light having two or more single modes; the beam shape and the power distribution of the laser light L5 may be varied.

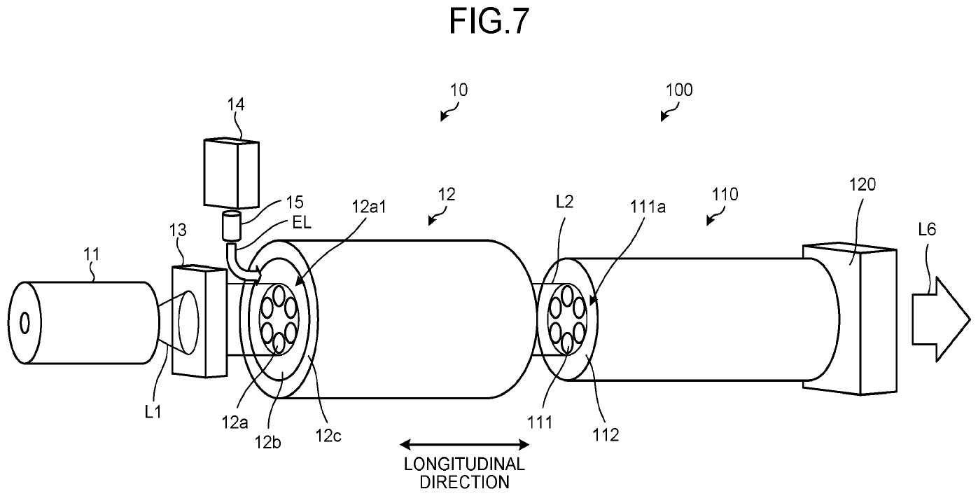

FIG. 7 is a schematic configuration diagram of a processing device according to a fourth embodiment. A processing device 100 is a device for performing a variety of laser processing such as welding and cutting. The laser device 10 according to the first embodiment includes a delivery fiber 110 and an optical head 120.

The delivery fiber 110 is optically connected to the multicore gain fiber 12 of the laser device 10 according to, for example, fusion splicing; and guides the laser light L2, which is output from the multicore gain fiber 12, to the optical head 120. The length of the delivery fiber 110 is greater than 1 m, is sometimes greater than 10 m, and is sometimes greater than 20 m too. The multicore gain fiber 12 represents an example of a gain fiber unit, and the delivery fiber 110 represents an example of a delivery fiber unit. Thus, the processing device 100 may be said to include a laser device that includes a multicore fiber having a gain fiber unit and a delivery fiber unit.

The optical head 120 uses an optical system such as a spatial optical system to concentrate and shape the laser light L2 guided thereto by the delivery fiber 110, and outputs a laser light L6. Then, the laser light L6 is bombarded onto, for example, a workpiece and is used in the desired laser processing.

Given below is the more detailed explanation about the delivery fiber 110. The delivery fiber 110 includes one core group 111a having six cores 111, and includes a cladding 112 that surrounds the outer periphery of the cores 111. Thus, the delivery fiber 110 is a six-core-type multicore fiber.

In an identical manner to the cores 12a of the multicore gain fiber 12, the cores 111 are arranged in a circular pattern along the cross-sectional surface orthogonal to the longitudinal direction. Then, for example, the cores 12a of the multicore gain fiber 12 and the cores 111 of the delivery fiber 110 are fusion-spliced in such a way that their optical axes are coincident. The cores 111 are doped with, for example, germanium (Ge) or aluminum (Al) as a refractive-index adjustment dopant meant for increasing the refractive index. Moreover, the cores 111 represent transmission fibers that do not include an optical amplification medium and that are meant for transmitting light at a low loss.

In an identical manner to the multicore gain fiber 12, in the core group 111a, each of the six cores 111 is optically connected to its neighboring cores 111.

The cladding 112 has a lower refractive index than the maximum refractive index of the core 111. The refractive index profile of each core 111 is, for example, of the step-index type. However, there is no particular restriction regarding that.

If the outer diameter of the cladding 112 (i.e., the cladding diameter) is either equal to or different by ±60% than the outer diameter of the inner cladding 12b of the multicore gain fiber 12, then it becomes easier to perform fusion-splicing of the delivery fiber 110 and the multicore gain fiber 12.

Herein, the core diameter and the refractive index of each core 111 and the relative refractive index difference of each core 111 with respect to the cladding 112 is set in such a way that each core 111 propagates through the light having the wavelength of the laser light L1 (or the laser light L2) in the single mode (LP01 mode). It is desirable that the core diameter of each core 111 is, for example, equal to or greater than 9 μm and equal to or smaller than 25 μm. Meanwhile, although it is desirable that all cores 111 have the same core diameter and the same refractive index, it is not always a necessary condition. Moreover, as long as the mode field diameter or the numerical aperture (NA) of each core 111 at the wavelength of the laser light L1 is either equal to or different by ±40% of the mode field diameter or the numerical aperture (NA) of each core 12a of the multicore gain fiber 12 at the wavelength of the laser light L1, the connection loss becomes lower.

In the processing device 100 configured in the manner explained above, the laser light L2 output from the multicore gain fiber 12 propagates through the core group 111a of the delivery fiber 110 in the same super mode as the propagation mode in the multicore gain fiber 12. In this type of processing device, the delivery fiber is relatively long, and there are times when the impact of the nonlinear optical phenomena in the delivery fiber becomes an issue. In contrast, in the processing device 100, the propagation of the laser light L2 in the delivery fiber 110 may be achieved while keeping the intensity and the density of the laser light L2 at a relatively lower level. As a result, the impact of the nonlinear optical phenomena may be held down, thereby making the condition suitable to achieve a high level of power.

Moreover, the processing device 100 enjoys the advantages of the laser device 10. That is, not only the configuration is simple, but also the power of the laser light L6 has a high level of temporal stability.

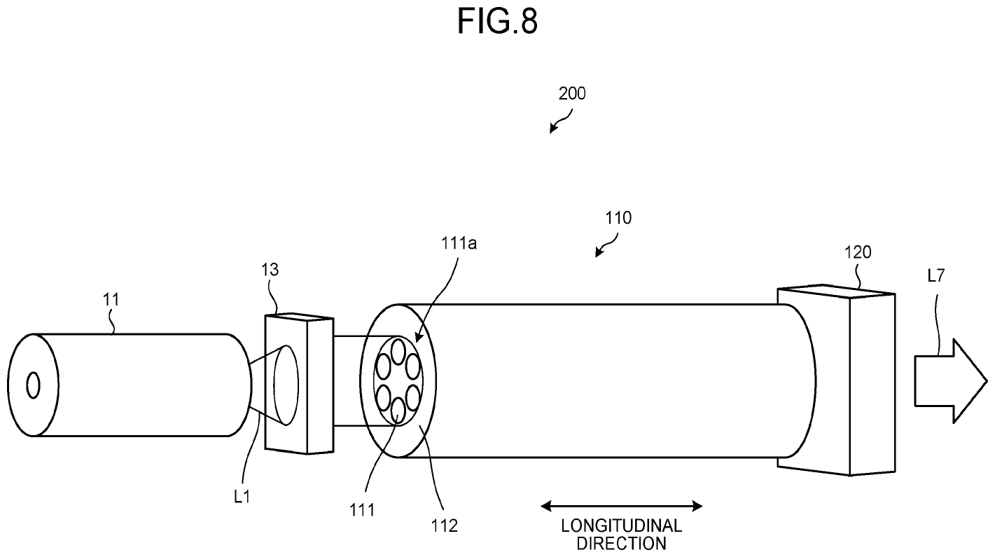

FIG. 8 is a schematic configuration diagram of a processing device according to a fifth embodiment. A processing device 200 is configured by removing the multicore gain fiber 12, the pumping light source 14, and the pumping light coupler 15 from the configuration of the processing device 100 according to the fourth embodiment. Thus, the processing device 200 may be said to include a laser device that includes the seed light source 11, the optical coupler 13, and the delivery fiber 110.

In the processing device 200, the optical coupler 13 receives the laser light L1 output by the seed light source 11, and inputs the laser light L1 to the core group 111a of the delivery fiber 110.

In the delivery fiber 110, the laser light L1 propagates through the core group 111a in the super mode.

The optical head 120 uses an optical system such as a spatial optical system to concentrate and shape the laser light L1 guided thereto by the delivery fiber 110, and outputs a laser light L7.

In the processing device 200 configured in the manner explained above, the laser light L1 propagates through the core group 111a of the delivery fiber 110 in the super mode. In the processing device 200, the propagation of the laser light L1 in the delivery fiber 110 may be achieved while keeping the intensity and the density of the laser light L1 relatively lower. As a result, the impact of the nonlinear optical phenomena may be held down, thereby making the condition suitable to achieve a high level of power.

Moreover, the processing device 200 enjoys the advantages of the laser device 10. That is, not only the configuration is simple, but also the power of the laser light L7 has a high level of temporal stability.

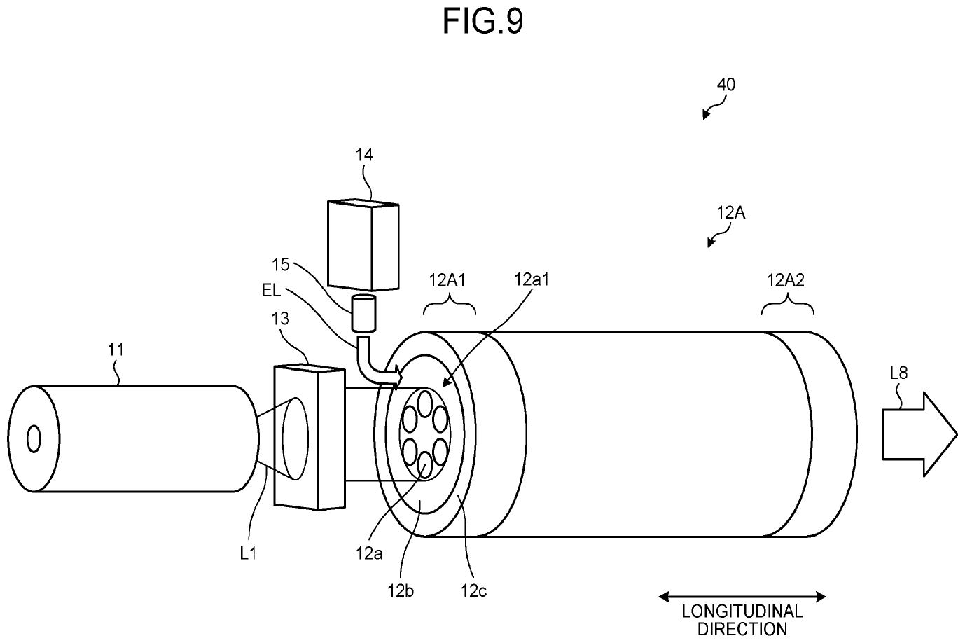

FIG. 9 is a schematic configuration diagram of a laser device according to a sixth embodiment. A laser device 40 is configured by substituting a multicore gain fiber 12A for the multicore gain fiber 12 in the laser device 10 illustrated in FIG. 1 according to the first embodiment.

The multicore gain fiber 12A is configured by providing FBG regions 12A1 and 12A2 (FBG stands for Fiber Bragg Grating) at the end portions in the longitudinal direction of the multicore gain fiber 12.

In the multicore gain fiber 12A, the FBG region 12A1 is provided on the near side to the optical coupler 13. In the FBG region 12A1, fiber bragg grating having a relatively higher reflectance (for example, 80% or more) at the wavelength of the laser light L1 is formed in each core 12a. Such fiber bragg grating is also called high reflection (or high reflector) fiber bragg grating (HR-FBG).

In the multicore gain fiber 12A, the FBG region 12A2 is provided on the far side from the optical coupler 13. In the FBG region 12A2, fiber bragg grating having a relatively lower reflectance (for example, 10% to 30%) at the wavelength of the laser light L1 is formed in each core 12a. Such fiber bragg grating is also called output coupler fiber bragg grating (OC-FBG).

In each core 12a, the HR-FBG formed in the FBG region 12A1 and the OC-FBG formed in the FBG region 12A2 constitute an optical resonator.

In the laser device 40 configured in the manner explained above, the multicore gain fiber 12A functions as a laser resonator; performs lasing using the laser light L1, which is input from the seed light source 11, as the seed light; and outputs a laser light L8 having the same wavelength as the laser light L1.

In an identical manner to the laser device 10, the laser device 40 is suitable to achieve a high level of power and has a simple configuration, and the power of the laser light L8 has a high level of temporal stability.

Meanwhile, with reference to FIG. 9, fiber bragg grating is directly formed in each core 12a. However, the manner of formation of fiber bragg grating is not limited to that example. Alternatively, for example, separate multicore fibers having fiber bragg grating formed in their cores may be connected to both ends of the multicore gain fiber 12 by fusion-splicing.

The optical coupler 13 may be configured to receive the laser light L1 that is output by the seed light source 11, and to input the laser light L1 to a core group (for example, the core group 12a1). Herein, an optical coupler of various known types may be used. For example, as the optical coupler 13, a coupling system may be used that includes an individual single-mode optical fiber for receiving the laser light L1 and a spatial optical system (lens) that inputs the laser light L1 to a core group. In that case, an optical isolator may be inserted in between the single-mode optical fiber and the spatial optical system. Alternatively, as the optical coupler 13, an optical fiber bundle may be used in which a plurality of single-core single-mode optical fibers separated from each other is placed at one end, and those single-mode optical fibers are bundled at the other end. Still alternatively, as the optical coupler 13, an optical-fiber-type optical coupler called a photonic lantern may be used. In a photonic lantern, for example, a plurality of single-core single-mode optical fibers separated from each other is placed at one end, and those single-mode optical fibers are bundled to form a single-core multimode optical fiber at the other end. Still alternatively, as the optical coupler 13, a deformable mirror may be used that is equipped with micro electric mechanical systems (MEMS). A deformable mirror is capable of separating the input laser light L1 into a plurality of components and inputting each component to each core of a core group. Moreover, if the deformable mirror is actively controllable, then it becomes possible to perform control for actively making the phases of the components of the laser light L1 uniform and to perform control for actively varying the power ratio of the components of the laser light L1 input to each of a plurality of core groups.

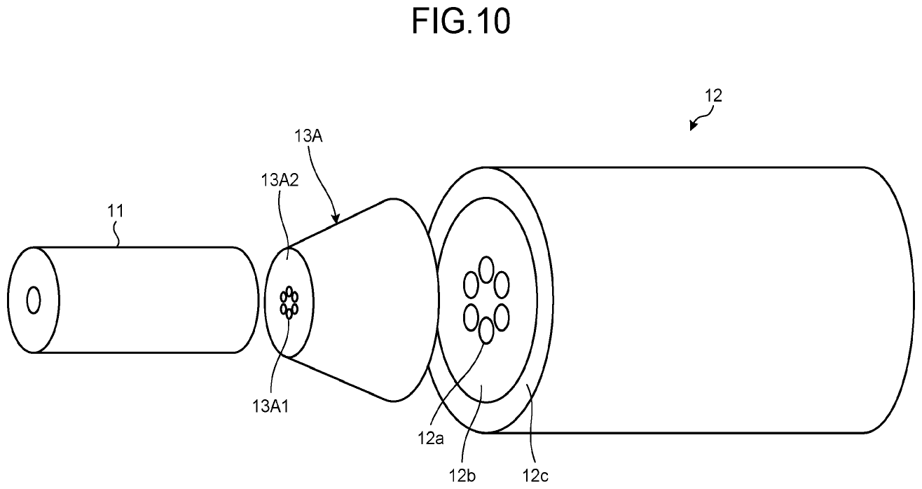

Meanwhile, as the optical coupler 13, a tapering-type multicore fiber may also be used. FIG. 10 is a schematic diagram for explaining a tapering-type multicore fiber as an exemplary configuration of the optical coupler. A tapering-type multicore fiber 13A includes six cores 13A1 placed in a circular manner, and a cladding 13A2 that surrounds the core 13A1. The diameter of the cores 13A1 and the diameter of the cladding 13A2 expands in a tapered manner from the seed light source 11 toward the multicore gain fiber 12. The tapering-type multicore fiber 13A is fusion-spliced to the seed light source 11 as well as to the multicore gain fiber 12. At the connection end face on the side of the seed light source 11, it is desirable that the core diameter of the cores 13A1 and the diameter of the circular ring are set to ensure a decrease in the fusion-splicing loss of the seed light source 11. At the connection end face on the side of the multicore gain fiber 12, it is desirable that the mode field diameter and the arrangement of the cores 13A1 is set to be same as or close to the mode field diameter and the arrangement of the cores 12a of the multicore gain fiber 12.

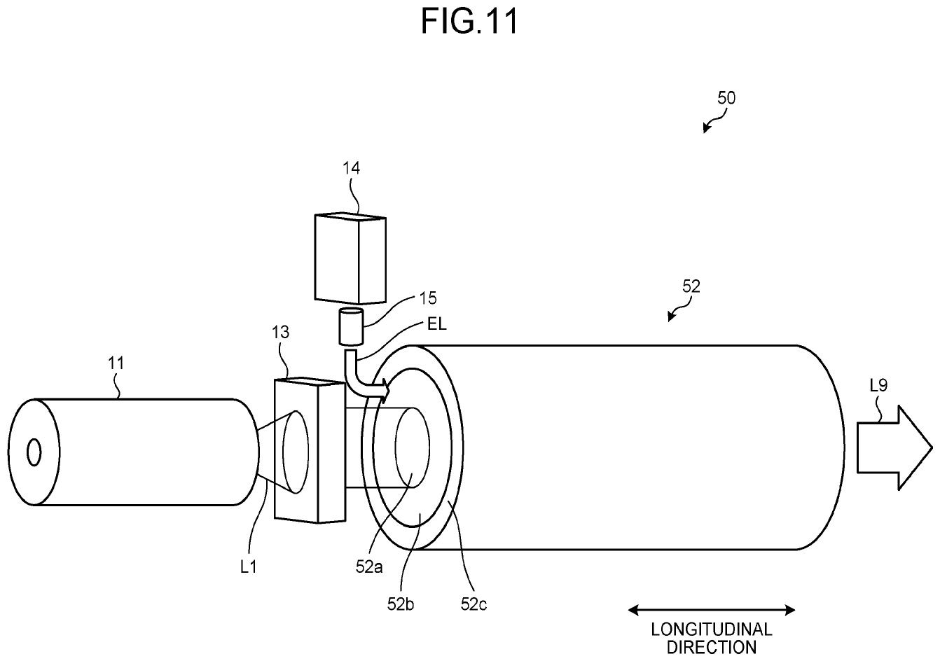

FIG. 11 is a schematic configuration diagram of a laser device according to a reference embodiment. A laser device 50 is configured by substituting a single-core gain fiber 52 for the multicore gain fiber 12 in the configuration of the laser device 10 illustrated in FIG. 1 according to the first embodiment. Regarding the constituent elements also included in the laser device 10, the explanation is not given again.

The single-core gain fiber 52 includes a core 52a; an inner cladding 52b that surrounds the outer periphery of the core 52a; and an outer cladding that surrounds the outer periphery of the inner cladding 52b. Thus, the single-core gain fiber 52 is a double-cladding-type gain fiber. The inner cladding 52b and an outer cladding 52c included in the single-core gain fiber 52 are same as the inner cladding 12b and the outer cladding 12c included in the multicore gain fiber 12. Hence, their explanation is not given again.

The core 52a is doped with, for example, germanium (Ge) or aluminum (Al) as a refractive-index adjustment dopant meant for increasing the refractive index. Moreover, the core 52a is doped with ytterbium (Yb) that is a rare earth element representing an optical amplification medium.

The refractive index profile of the core 52a is, for example, of the step-index type. However, there is no particular restriction regarding that. Moreover, the core diameter and the refractive index of the core 52a and the relative refractive index difference of the core 52a with respect to the inner cladding 52b is set in such a way that the light having the wavelength of the laser light L1 propagates through the core 52a in the multimode. Thus, the core 52a is also called a multimode core.

Regarding the operations performed in the laser device 50, the following explanation is given mainly about the differences with the laser device 10. When the core 52a is subjected to light excitation by the pumping light EL and when the laser light L1 is in the amplifiable state, the optical coupler 13 inputs the laser light L1 to the core 52a. Due to the optical coupler 13, the laser light L1 excites a predetermined propagation mode from among the multiple modes of the cores 52a.

In the single-core gain fiber 52, the laser light L1 that is input to the core 52a propagates through the core 52a while maintaining the excited propagation mode. As a result, the laser light L1 propagates through the core 52a while getting amplified, and is output as a laser light L9 in the amplified form from the single-core gain fiber 52.

Since the core 52a is a multimode core, it has a greater cross-sectional area than a single-mode core. Hence, the laser light L1 propagating through the core 52a has a lower intensity and a lower density than in the case of propagating through a single-mode core.

In the laser device 50 configured in the manner explained above, in the single-core gain fiber 52, since the laser light L1 may be amplified while keeping its intensity and density to a relatively lower level, the impact of the nonlinear optical phenomena may be held down, thereby making the condition suitable to achieve a high level of power.

Meanwhile, if the optical coupler 13 inputs the laser light L1 to the core 52a of the single-core gain fiber 52 in such a way that an axisymmetric propagation mode is excited in the core 52a, then the power of the output laser light L9 has a high level of temporal stability. Hence, that is a desirable scenario. However, alternatively, a non-axisymmetric propagation mode may also be excited in the core 52a. Still alternatively, in the case of exciting an axisymmetric mode as well as a non-axisymmetric mode, it is desirable to pay attention to satisfying the required level of stability. For example, if the laser light L9 includes the components of an axisymmetric propagation mode as well as the components of a non-axisymmetric propagation mode, then the ratio of the power of the components of the non-axisymmetric propagation mode with respect to the ratio of the power of the axisymmetric propagation mode (i.e., the extinction ratio) is desirably equal to or smaller than −10 dB and is more desirably equal to or smaller than −20 dB from the perspective of stability.

Meanwhile, in the embodiments described above, when a multicore fiber includes a plurality of core groups, along the cross-sectional surface orthogonal to the longitudinal direction of the multicore fiber, one of the core groups is placed in a circular pattern around the other core groups. However, the embodiments of the present disclosure are not limited to that case. Alternatively, for example, as a modification example of the multicore gain fiber 32 according to the third embodiment, a multicore gain fiber may include two same core groups 32a2 as a plurality of core groups.

As other modification examples of the multicore gain fiber 32, following multicore gain fibers may also be implemented in the laser device according to the embodiments of the present disclosure: a multicore gain fiber having a triplex structure in which a separate core group is further placed in a circular pattern around the core group 32a1; or a multicore gain fiber having a structure of four or more layers in which separate core groups are further placed in a circular pattern. In the case of such a multilayered structure, the circular patterns either may be concentric in nature with their centers coincident with each other or may have different centers.

Meanwhile, the multicore fiber according to the embodiments of the present disclosure is not limited to have a circular arrangement of cores in a core group. Alternatively, the cores included in a core group may be arranged in polygonal rings. Still alternatively, the cores included in a core group may be arranged in, for example, a linear pattern, a square lattice, or a rectangular lattice.

Meanwhile, in the embodiments described above, the cores of a multicore gain fiber are doped with ytterbium (Yb) that is a rare earth element representing an optical amplification medium. Alternatively, as a rare earth element, the cores may be doped with erbium (Er), erbium (Er) and ytterbium (Yb), thulium (Tm), or holmium (Ho). When a particular rare earth element is included, the laser light that should be output by the seed light source has the wavelength corresponding to the amplifiable wavelength band of that rare earth element. For example, when erbium (Er) is included or when erbium (Er) and ytterbium (Yb) are included, the wavelength is equal to 1550 nm, for example. When thulium (Th) or holmium (Ho) is included, the wavelength is equal to 2 μm, for example.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

According to the present disclosure, it becomes possible to provide a laser device that has a simple configuration and that is suitable to achieve a high level of power.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A laser device comprising:
a seed light source configured to output a laser light having a single mode;
a multicore fiber including at least one core group having at least one core, each of the core in the core group being optically coupled to neighboring cores; and
an optical coupler configured to input the laser light to the core group, wherein
in the multicore fiber, the laser light propagates through the core group in a super mode representing propagation mode of the core group.

2. The laser device according to claim 1, wherein the laser light propagates through the core group in a fundamental mode of the super mode.

3. The laser device according to claim 1, wherein, along a cross-sectional surface orthogonal to a longitudinal direction of the multicore fiber, a plurality of the core included in the core group is arranged in a hexagonal close-packed state or in a circular pattern.

4. The laser device according to claim 1, wherein
the multicore fiber includes a plurality of the core group, and
the cores included in mutually different of the core groups are not optically coupled to each other.

5. The laser device according to claim 4, wherein, along a cross-sectional surface orthogonal to a longitudinal direction of the multicore fiber, the cores included in one of the plurality of core groups are arranged in a circular pattern around remaining of the core groups.

6. The laser device according to claim 4, wherein a ratio of power of the laser light propagating through the plurality of core groups is variable.

7. The laser device according to claim 4, wherein the seed light source is configured to output a plurality of the laser light output to each of the plurality of core groups.

8. The laser device according to claim 1, wherein the multicore fiber is a gain fiber in which the core is doped with an optical amplification medium.

9. The laser device according to claim 8, wherein, in the multicore fiber, the core is doped with either only ytterbium or erbium and ytterbium as the optical amplification medium.

10. The laser device according to claim 1, wherein the multicore fiber is a delivery fiber in which the core is not doped with an optical amplification medium.

11. The laser device according to claim 1, wherein the multicore fiber includes
a gain fiber unit in which the core is doped with an optical amplification medium, and
a delivery fiber unit in which the core is not doped with an optical amplification medium.

12. The laser device according to claim 1, wherein the optical coupler is one of: an optical system including a single-mode optical fiber and a spatial optical system; a tapering multicore fiber; an optical fiber bundle; a photonic lantern; and a deformable mirror.

13. A processing device comprising the laser device according to claim 1.
